(19) United States
(12) Patent Application Publication
(10) Pub. No.: US 2026/0119815 A1
(43) Pub. Date: Apr. 30, 2026

(54) INFORMATION PROCESSING APPARATUS, INFORMATION PROCESSING METHOD, AND NON-TRANSITORY RECORDING MEDIUM

(71) Applicant: NEC Corporation, Tokyo (JP)

(72) Inventors: Takashi SHIBATA, Tokyo (JP); Naoya Sogi, Tokyo (JP); Makoto Terao, Tokyo (JP); Masahiro Yamaguchi, Tokyo (JP); Takuya Ogawa, Tokyo (JP); Toshinori Hosoi, Tokyo (JP); Tetsuaki Suzuki, Tokyo (JP); Yuichi Abe, Tokyo (JP); Shoko Wakizaka, Tokyo (JP); Anri Sueyoshi, Tokyo (JP); Shoichi Yonekura, Tokyo (JP); Kensaku Onda, Tokyo (JP); Eriko Kondo, Tokyo (JP); Yuki Hanzawa, Tokyo (JP); Eisuke Tsuda, Tokyo (JP); Rie Iwasaki, Tokyo (JP); Kazuto Takizawa, Tokyo (JP); Takashi Takeuchi, Tokyo (JP)

(73) Assignee: NEC Corporation, Tokyo (JP)

(21) Appl. No.: 19/351,536

(22) Filed: Oct. 7, 2025

(30) Foreign Application Priority Data
Oct. 29, 2024 (JP) 2024-190025

(51) Int. Cl. G06F 40/40; G01S 13/08; G06T 7/11; G06T 7/20; G06T 11/00

(52) U.S. Cl. CPC G06F 40/40; G01S 13/08; G06T 7/11; G06T 7/20; G06T 11/00; G06T 2207/20021; G06T 2207/30241

(57) ABSTRACT

The information processing apparatus includes an acquisition unit for acquiring sensor information indicating a sensing result by a sensor that senses a space and environmental information regarding an environment of the space, a guide information acquisition unit for acquiring guide information indicating at least one of a shape of a target included in the space, a trajectory of movement of the target, a relationship between the targets, and a boundary in the space, a text generation unit for generating a text describing the space using the sensor information, the guide information, and the environmental information, and a text output unit for outputting the text generated by the text generation unit.

### INCORPORATION BY REFERENCE

This application is based upon and claims the benefit of priority from Japanese patent application No. 2024-190025, filed on Oct. 29, 2024, the disclosure of which is incorporated herein in its entirety by reference.

### TECHNICAL FIELD

The present disclosure relates to an information processing apparatus, an information processing method, and a non-transitory recording medium.

### BACKGROUND ART

Techniques for supporting creation of sentences such as reports have been proposed. Examples of the techniques for supporting the creation of sentences include the technology described in JP 7455452 B1. JP 7455452 B1 discloses an information processing system that causes a first user terminal to display a selection screen for receiving a selection operation for a type of an application document, instructs an artificial intelligence having a sentence creation function to create a sentence of an application document of a type selected by the selection operation, causes the first user terminal to display the application document created by the instruction in an editable manner, and causes a second user terminal of a corrector who is familiar with the type of the application document selected to display a request for correction of the application document edited in the first user terminal.

### SUMMARY

Meanwhile, there is a case where a user who creates a sentence such as a report wishes to create the sentence focusing on a specific region or a specific event in a space to be monitored. The technique described in JP 7455452 B1 has a problem that it is difficult to generate a sentence having contents focusing on an event that a user wants to focus on.

The present disclosure has been made in view of the above problems, and an example object of the present disclosure is to provide a technique for generating a text of a content focused on a specific event in a space to be monitored.

An information processing apparatus according to an example aspect of the present disclosure includes an acquisition means for acquiring sensor information indicating a sensing result by a sensor that senses a space and environmental information regarding an environment of the space, a guide information acquisition means for acquiring guide information indicating at least one of a shape of a target included in the space, a trajectory of movement of the target, a relationship between targets, and a boundary in the space, a text generation means for generating a text describing the space using the sensor information, the guide information, and the environmental information, and a text output means for outputting a text generated by the text generation means.

An information processing method according to an example aspect of the present disclosure includes acquisition processing of acquiring, by at least one processor, sensor information indicating a sensing result by a sensor that senses a space and environmental information regarding an environment of the space, guide information acquisition processing of acquiring, by the at least one processor, guide information indicating at least one of a shape of a target included in the space, a trajectory of movement of the target, a relationship between targets, and a boundary in the space, text generation processing of generating, by the at least one processor, a text describing the space using the sensor information, the guide information, and the environmental information, and text output processing of outputting, by the at least one processor, a text generated in the text generation processing.

An information processing program according to an example aspect of the present disclosure is an information processing program for causing a computer to function as an information processing apparatus, the information processing program causing the computer to function as an acquisition means for acquiring sensor information indicating a sensing result by a sensor that senses a space and environmental information regarding an environment of the space, a guide information acquisition means for acquiring guide information indicating at least one of a shape of a target included in the space, a trajectory of movement of the target, a relationship between targets, and a boundary in the space, a text generation means for generating a text describing the space using the sensor information, the guide information, and the environmental information, and a text output means for outputting a text generated by the text generation means.

According to an example aspect of the present disclosure, there is an exemplary effect that it is possible to provide a technology of generating a text of a content focusing on a specific event in a space to be monitored.

### BRIEF DESCRIPTION OF DRAWINGS

FIG. 1 is a block diagram illustrating a configuration of an information processing apparatus according to the present disclosure;

FIG. 2 is a flowchart illustrating a flow of an information processing method according to the present disclosure;

FIG. 3 is a block diagram illustrating a configuration of an information processing apparatus according to the present disclosure;

FIG. 4 is a block diagram illustrating an example of a functional configuration of an information processing apparatus according to the present disclosure;

FIG. 5 is a diagram illustrating an example of an image displayed by a display control unit according to the present disclosure;

FIG. 6 is a diagram illustrating a specific example of guide information according to the present disclosure; and

FIG. 7 is a block diagram illustrating a configuration of a computer that functions as an information processing apparatus according to the present disclosure.

### EXAMPLE EMBODIMENT

Hereinafter, example embodiments of the present invention will be described. However, the present invention is not limited to the following illustrative example embodiments, and various modifications can be made within a scope described in the claims. For example, example embodiments obtained by appropriately combining technologies (some or all of things or methods) adopted in the following illustrative example embodiments can also be included in the scope of the present invention. Example embodiments obtained by appropriately omitting some of the technologies adopted in the following illustrative example embodiments can also be included in the scope of the present invention. Effects mentioned in the following illustrative example embodiments are examples of effects expected in the illustrative example embodiments, and do not define extension of the present invention. That is, example embodiments that do not achieve the effects mentioned in the following illustrative example embodiments can also be included in the scope of the present invention.

### First Illustrative Example Embodiment

A first illustrative example embodiment that is an example of the example embodiments of the present invention will be described in detail with reference to the drawings. The present illustrative example embodiment is a basic form of each illustrative example embodiment to be described below. An application range of each technology adopted in the present illustrative example embodiment is not limited to the present illustrative example embodiment. In other words, each technology adopted in the present illustrative example embodiment can also be adopted in another illustrative example embodiment included in the present disclosure within a range in which no particular technical problem occurs. Each technique illustrated in the drawings referred to for description of the present illustrative example embodiment can also be adopted in the other illustrative example embodiments included in the present disclosure within a range in which no particular technical problem occurs.

### (Configuration of Information Processing Apparatus)

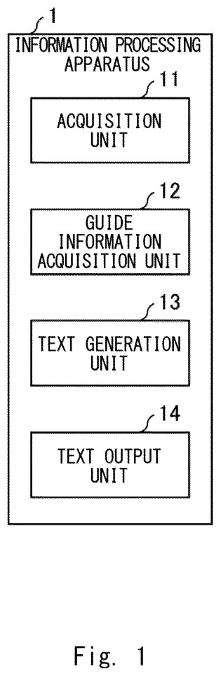

A configuration of an information processing apparatus 1 will be described with reference to FIG. 1. FIG. 1 is a block diagram illustrating a configuration of the information processing apparatus 1. As illustrated in FIG. 1, the information processing apparatus 1 includes an acquisition unit 11, a guide information acquisition unit 12, a text generation unit 13, and a text output unit 14. The acquisition unit 11 acquires sensor information indicating a sensing result by a sensor that senses a space and environmental information regarding an environment of the space. The guide information acquisition unit 12 acquires guide information indicating at least one of a shape of a target included in the space, a trajectory of movement of the target, a relationship between the targets, and a boundary in the space. The text generation unit 13 generates a text describing the space using the sensor information, the guide information, and the environmental information. The text output unit 14 outputs the text generated by the text generation unit 13.

### (Effects of Information Processing Apparatus)

As described above, the information processing apparatus 1 employs a configuration including the acquisition unit 11 that acquires sensor information indicating a sensing result by a sensor that senses a space and environmental information regarding an environment of the space, the guide information acquisition unit 12 that acquires guide information indicating at least one of a shape of a target included in the space, a trajectory of movement of the target, a relationship between the targets, and a boundary in the space, the text generation unit 13 that generates a text describing the space using the sensor information, the guide information, and the environmental information, and the text output unit 14 that outputs the text generated by the text generation unit 13. Therefore, according to the information processing apparatus 1, it is possible to obtain an effect of generating a text of a content focusing on a specific event in a space to be monitored.

### (Flow of Information Processing Method)

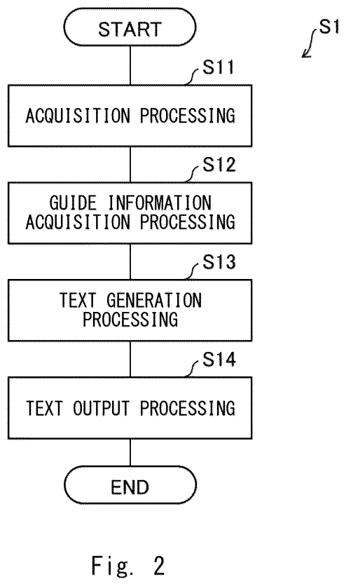

A flow of an information processing method S1 will be described with reference to FIG. 2. FIG. 2 is a flowchart illustrating the flow of the information processing method S1. As illustrated in FIG. 2, the information processing method S1 includes acquisition processing S11, guide information acquisition processing S12, text generation processing S13, and text output processing S14.

In the acquisition processing S11, at least one processor acquires sensor information indicating a sensing result by a sensor that senses a space and environmental information regarding an environment of the space. In the guide information acquisition processing S12, the at least one processor acquires the guide information indicating at least one of the shape of the target included in the space, the trajectory of the movement of the target, the relationship between the targets, and the boundary in the space. In the text generation processing S13, the at least one processor generates a text describing the space using the sensor information, the guide information, and the environmental information. In the text output processing S14, the at least one processor outputs the text generated in the text generation processing S13.

### (Effects of Information Processing Method)

As described above, the information processing method S1 adopts a configuration including the acquisition processing S11 of acquiring, by at least one processor, sensor information indicating a sensing result by a sensor that senses a space and environmental information regarding an environment of the space, the guide information acquisition processing S12 of acquiring, by the at least one processor, guide information indicating at least one of a shape of a target included in the space, a trajectory of movement of the target, a relationship between the targets, and a boundary in the space, the text generation processing S13 of generating, by the at least one processor, a text describing the space using the sensor information, the guide information, and the environmental information, and the text output processing S14 of outputting, by the at least one processor, the text generated in the text generation processing S13. Therefore, according to the information processing method S1, it is possible to obtain an effect of generating a text of contents focusing on a specific event in a space to be monitored.

### Second Illustrative Example Embodiment

A second illustrative example embodiment that is an example of the example embodiments of the present invention will be described in detail with reference to the drawings. Components that have the same functions as the components described in the above-described illustrative example embodiment are denoted by the same reference signs, and description of the components will be appropriately omitted. An application range of each technology adopted in the present illustrative example embodiment is not limited to the present illustrative example embodiment. In other words, each technology adopted in the present illustrative example embodiment can also be adopted in another illustrative example embodiment included in the present disclosure within a range in which no particular technical problem occurs. Each technique illustrated in each of the drawings referred to for describing the present illustrative example embodiment can be employed in the other illustrative example embodiments included in the present disclosure within the scope in which no particular technical problem occurs.

### (Configuration of Information Processing Apparatus)

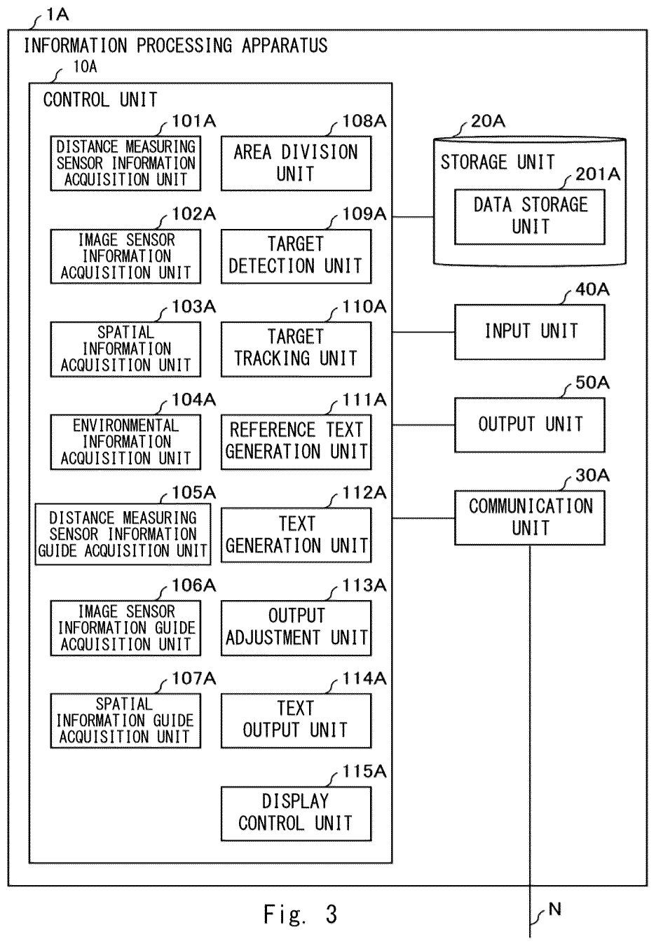

A configuration of the information processing apparatus 1A according to the present disclosure will be described with reference to FIG. 3. FIG. 3 is a block diagram illustrating the configuration of the information processing apparatus 1A. The information processing apparatus 1A includes a control unit 10A, a storage unit 20A, a communication unit 30A, an input unit 40A, and an output unit 50A. The communication unit 30A communicates with a device outside the information processing apparatus 1A via a communication line N. The communication unit 30A transmits data supplied from the control unit 10A to another device, and supplies data received from another device to the control unit 10A.

### (Input Unit/Output Unit)

The input unit 40A is a configuration for receiving an input to the information processing apparatus 1A, and includes, as an example, an input device such as a keyboard, a mouse, a touch panel, a camera, or a microphone. The input unit 40A may be configured to receive data from the input device via, for example, an interface such as a universal serial bus (USB). The output unit 50A is a configuration for performing output from the information processing apparatus 1A, and includes, as an example, an output device such as a display, a printer, a touch panel, or a speaker. The output unit 50A may include, for example, an interface such as a USB, and may be configured to output data to the output device via the interface.

### (Storage Unit)

The storage unit 20A stores various types of information to be referred to by the control unit 10A. The storage unit 20A particularly includes a data storage unit 201A. The data storage unit 201A stores various data such as guide information acquired by a distance measuring sensor information guide acquisition unit 105A to be described later, guide information acquired by an image sensor information guide acquisition unit 106A to be described later, guide information acquired by a spatial information guide acquisition unit 107A to be described later, and a reference text generated by a reference text generation unit 111A to be described later.

### (Control Unit)

The control unit 10A includes a distance measuring sensor information acquisition unit 101A, an image sensor information acquisition unit 102A, a spatial information acquisition unit 103A, an environmental information acquisition unit 104A, a distance measuring sensor information guide acquisition unit 105A, an image sensor information guide acquisition unit 106A, a spatial information guide acquisition unit 107A, an area division unit 108A, a target detection unit 109A, a target tracking unit 110A, a reference text generation unit 111A, a text generation unit 112A, an output adjustment unit 113A, a text output unit 114A, and a display control unit 115A.

The distance measuring sensor information acquisition unit 101A, the image sensor information acquisition unit 102A, the spatial information acquisition unit 103A, and the environmental information acquisition unit 104A are examples of acquisition means according to the present disclosure. The distance measuring sensor information guide acquisition unit 105A, the image sensor information guide acquisition unit 106A, and the spatial information guide acquisition unit 107A are examples of a guide information acquisition means according to the present disclosure. The area division unit 108A, the target detection unit 109A, the target tracking unit 110A, and the reference text generation unit 111A are examples of an area division means, a target detection means, a target tracking means, and a reference text generation means according to the present disclosure. The text generation unit 112A, the output adjustment unit 113A, the text output unit 114A, and the display control unit 115A are examples of a text generation means, an output adjustment means, a text output means, and a display control means according to the present disclosure.

### (Distance Measuring Sensor Information Acquisition Unit)

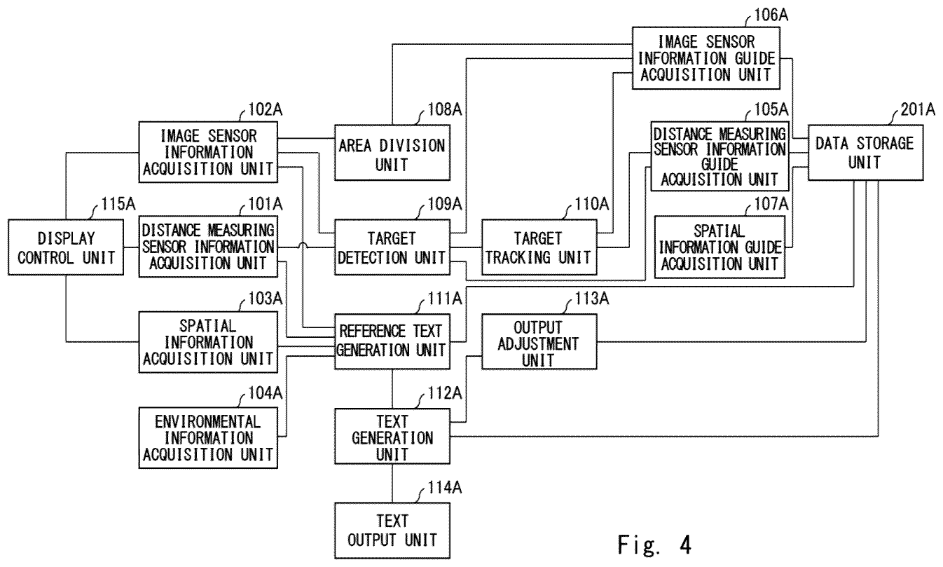

FIG. 4 is a block diagram illustrating an example of a functional configuration of the information processing apparatus 1A. The distance measuring sensor information acquisition unit 101A acquires distance measuring sensor information indicating a sensing result by the distance measuring sensor. Examples of the distance measuring sensor include radar and laser imaging detection and ranging (LIDAR). Examples of the distance measuring sensor information include information indicating a measurement result by radar or LIDAR.

As an example, the distance measuring sensor information acquisition unit 101A acquires the distance measuring sensor information input to the input unit 40A. The distance measuring sensor information acquisition unit 101A may receive the distance measuring sensor information from another device via the communication unit 30A. The distance measuring sensor information acquisition unit 101A may acquire distance measuring sensor information by reading the distance measuring sensor information from a storage destination (a storage device in the information processing apparatus 1A or a storage device outside the information processing apparatus 1A may be used) designated by the user of the information processing apparatus 1A. The distance measuring sensor information acquisition unit 101A may perform preprocessing such as noise removal processing on the distance measuring sensor information.

### (Image Sensor Information Acquisition Unit)

The image sensor information acquisition unit 102A acquires image sensor information indicating a sensing result by the image sensor. Examples of the image sensor include an event camera, an infrared camera, a monitoring camera, and an in-vehicle camera. Examples of the image sensor information include image data (multispectral image, SAR (Synthetic Aperture Radar) image, infrared image, monitoring image, in-vehicle image, and the like). The distance measuring sensor and the image sensor are examples of the sensor according to the present disclosure, and the distance measuring sensor information and the image sensor information are examples of the sensor information according to the present disclosure. In other words, it can also be said that the sensor information according to the present disclosure includes the distance measuring sensor information acquired from the distance measuring sensor and the image sensor information acquired from the image sensor.

As an example, the image sensor information acquisition unit 102A acquires the image sensor information input to the input unit 40A. The image sensor information acquisition unit 102A may receive the image sensor information from another device via the communication unit 30A. The image sensor information acquisition unit 102A may acquire image sensor information by reading the image sensor information from a storage destination (a storage device in the information processing apparatus 1A or a storage device outside the information processing apparatus 1A may be used) designated by the user of the information processing apparatus 1A. The image sensor information acquisition unit 102A may perform preprocessing such as noise removal processing on the image sensor information.

### (Spatial Information Acquisition Unit)

The spatial information acquisition unit 103A acquires environmental information regarding the environment of a space. Examples of the spatial information include information representing a map, a satellite image, or an aerial image. The spatial information may include information indicating the geography of the space (for example, information indicating latitude and longitude). As an example, the spatial information acquisition unit 103A acquires the spatial information input to the input unit 40A. The spatial information acquisition unit 103A may receive spatial information from another device via the communication unit 30A. The spatial information acquisition unit 103A may acquire spatial information by reading the spatial information from a storage destination (a storage device in the information processing apparatus 1A or a storage device outside the information processing apparatus 1A may be used) designated by the user of the information processing apparatus 1A.

### (Environmental Information Acquisition Unit)

The environmental information acquisition unit 104A acquires environmental information regarding the environment of a target. Examples of the environmental information include temperature, climate, topical information (external news such as an aircraft departing xx airport, etc.), observation information at another point (sensor information at another point, etc.), and date and time at which the sensor information is acquired. Examples of the observation information of another point include satellite data of another point and information indicating the weather of the surrounding environment.

As an example, the environmental information acquisition unit 104A acquires the environmental information input to the input unit 40A. The environmental information acquisition unit 104A may receive environmental information from another device via the communication unit 30A. The environmental information acquisition unit 104A may acquire environmental information by reading the environmental information from a storage destination (a storage device in the information processing apparatus 1A or a storage device outside the information processing apparatus 1A may be used) designated by the user of the information processing apparatus 1A.

### (Display Control Unit)

The display control unit 115A displays a first image represented by the distance measuring sensor information, a second image represented by the image sensor information, and a third image represented by the spatial information representing the space on the display device. As an example, the display control unit 115A outputs data representing the first image, data representing the second image, and data representing the third image to a display device connected to the output unit 50A, and causes the display device to display the image. The display control unit 115A may transmit the image data to another device connected via the communication unit 30A, and cause a display of the another device to display an image represented by the image data. Hereinafter, the first image, the second image, and the third image are displayed for inputting guide information to be described later. Hereinafter, in a case where there is no need to distinguish the first image, the second image, and the third image, these images are referred to as “guide input images”.

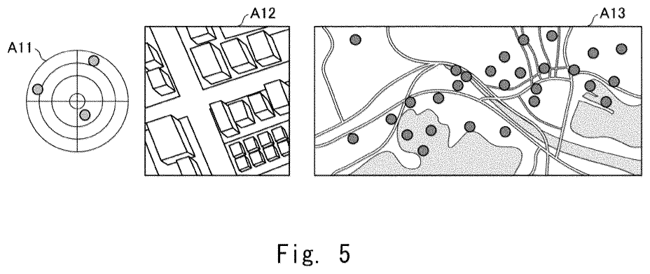

FIG. 5 is a diagram illustrating an example of an image displayed by the display control unit 115A. In the example of FIG. 5, an image A11 is an example of the first image represented by the distance measuring sensor information, and more specifically, is an image indicating a detection result of a target by the radar. An image A12 is an example of the second image represented by the image sensor information, and is more specifically an aerial photograph or a satellite photograph. An image A13 is an example of the third image represented by the spatial information, and more specifically, is an image representing a map. In the images A11 and A13, a target detected by a target detection unit 109A to be described later is displayed.

### (Guide Information)

On the screen on which the image illustrated in FIG. 5 is displayed, the user can input guide information. The guide information is information for indicating an event that the user wants to gaze at in the guide input image. As an example, the guide information is information indicating at least one of information (rectangular, etc.) designating a partial region in the space, a shape of a target included in the space, a trajectory of movement of the target, a relationship between targets, and a boundary (entry prohibited, etc.) in the space.

As an example, the user gives a rectangular guide to an important object or person. Alternatively, the user gives a past trajectory of a person or an object as a guide on the sensor information. Alternatively, a relationship between an object and a person is provided as an aid or the like. Alternatively, an important boundary line or region (entry prohibited area and passage prohibited area) on the sensor information is provided as a guide.

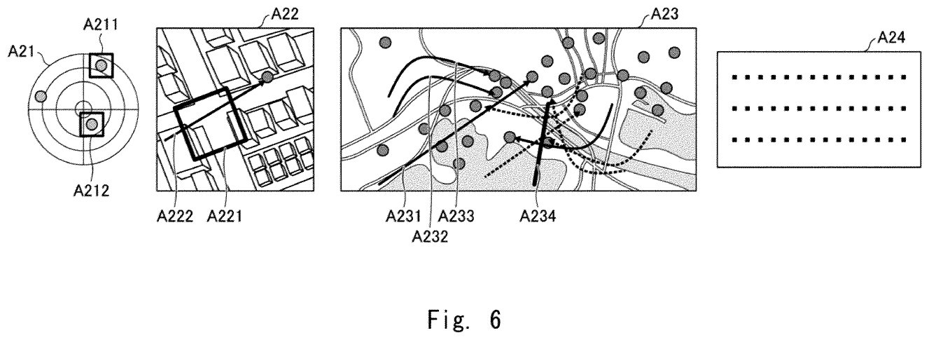

FIG. 6 is a diagram illustrating a specific example of the guide input image on which the guide information is superimposed. In the example of FIG. 6, an image A21 is an image in which figures A211 and A212 representing the guide information input by the user are superimposed on the guide input image represented by the distance measuring sensor information. The figures A211 and A212 are rectangles surrounding a target that the user wants to gaze at. An image A22 is an image in which figures A221 and A222 representing the guide information input by the user are superimposed on the guide input image represented by the image sensor information. The figure A221 is a rectangle indicating a region that the user wants to gaze at, and the figure A222 is an arrow indicating a trajectory of a target that the user wants to gaze at. An image A23 is an image in which figures A231 to A234 represented by the guide information input by the user are superimposed on the guide input image represented by the spatial information. The figures A231 to A234 are arrows indicating a movement trajectory of a target that the user wants to gaze at.

### (Distance Measuring Sensor Information Guide Acquisition Unit, Image Sensor Information Guide Acquisition Unit, and Spatial Information Guide Acquisition Unit)

The distance measuring sensor information guide acquisition unit 105A acquires guide information relevant to the first image represented by the distance measuring sensor information. The image sensor information guide acquisition unit 106A acquires guide information relevant to the second image represented by the image sensor information. The spatial information guide acquisition unit 107A acquires the guide information relevant to the third image represented by the spatial information.

The guide information acquired by the distance measuring sensor information guide acquisition unit 105A, the image sensor information guide acquisition unit 106A, and the spatial information guide acquisition unit 107A may be guide information input by the user, or may be other information. In a case where the guide information input by the user is acquired, in other words, the distance measuring sensor information guide acquisition unit 105A, the image sensor information guide acquisition unit 106A, and the spatial information guide acquisition unit 107A can acquire the guide information input by the user for at least one of the first image, the second image, and the third image displayed by the display control unit 115A.

As another example of the guide information, the guide information may include, for example, information indicating at least one of a detection result by the target detection unit 109A to be described later, a tracking result by the target tracking unit 110A to be described later, and a division result by the area division unit 108A. The user may correct these pieces of information, and the corrected information may be acquired as the guide information.

Each of the distance measuring sensor information guide acquisition unit 105A, the image sensor information guide acquisition unit 106A, and the spatial information guide acquisition unit 107A stores the acquired guide information and the guide input image in the data storage unit 201A. At this time, each of the distance measuring sensor information guide acquisition unit 105A, the image sensor information guide acquisition unit 106A, and the spatial information guide acquisition unit 107A may generate a superimposed image in which an image indicated by the acquired guide information is superimposed on the guide input image, and store the generated superimposed image in the data storage unit 201A as the guide information. In other words, the guide information can also be said to be information representing a superimposed image in which a figure representing at least one of the shape of the target included in the space, the trajectory of the movement of the target, the relationship between the targets, and the boundary in the space is superimposed on the guide input image (at least one of the image indicating the space and the image indicated by the sensor information).

### (Area Division Unit)

The area division unit 108A performs region division on the sensor information. As an example, the area division unit 108A divides the image into a plurality of areas based on the feature amount of the image indicated by the sensor information.

### (Target Detection Unit)

The target detection unit 109A detects a target existing in the space using the sensor information, and generates data indicating a detection result. Here, examples of the target include an aircraft, a ship, a drone, an automobile, a robot, a person, and an animal. However, the target is not limited to these. The data generated by the target detection unit 109A is, for example, coordinate data indicating a target area with a rectangle.

As an example, in a case where the sensor information is information indicating a measurement result by radar or LIDAR, the target detection unit 109A detects a target based on the measurement result by radar or LIDAR. In a case where the sensor information is image data (multispectral image, infrared image, etc.), the target detection unit 109A detects a target by a method using an object detection model such as YOLOX as an example. The method using the object detection model is not limited to YOLOX, and the target detection unit 109A may detect the target using other methods such as You Only Look Once (YOLO), a Vision Transformer (ViT), Regions with CNN features (Faster R-CNN), and a Single Shot MultiBox Detector (SSD).

### (Target Tracking Unit)

The target tracking unit 110A tracks a target detected by the target detection unit 109A by correlating the target in time series, and generates data indicating a tracking result. The data indicating the tracking result is, for example, time-series coordinates indicating each of the trajectories obtained by tracking by the target tracking unit 110A. As an example, in a case where the sensor information is information indicating a measurement result by radar or LIDAR, the target tracking unit 110A tracks the target by a method using a Kalman filter or the like. In a case where the sensor information is image data, the target tracking unit 110A tracks the target by a ByteTrack method as an example.

### (Reference Text Generation Unit)

The reference text generation unit 111A generates a reference text using the sensor information. The reference text is, for example, a text describing an image indicated by the sensor information. As an example, the reference text generation unit 111A generates the reference text based on output data obtained by inputting the sensor information to the generative model. As the generative model, for example, a model generated by the BLIP-2 (Bootstrapping Language-Image Pre-training with Frozen Image Encoders and Large Language Models) method can be used. In a case where the reference text generation unit 111A generates the reference text using the generative model, the input data input to the generative model includes, for example, at least one of sensor information, spatial information, and environmental information. The output of the generative model includes a reference text relevant to the input information (image data, etc.).

### (Text Generation Unit)

The text generation unit 112A generates a text describing the space using the sensor information, the guide information, and the environmental information. The text describing the space is, for example, an explanatory sentence focusing on a target or a region relevant to the guide information. As an example, the text is used as a report in a work of monitoring a space. Alternatively, the text may be used as, for example, an instruction related to the work of monitoring a space.

As an example, the text generation unit 112A generates the text based on output data obtained by inputting input data including the sensor information, the guide information, and the environmental information to a large-scale language model. Examples of the large-scale language model include, but are not limited to, generative AI such as ChatGPT (Chat Generative Pre-trained Transformer), GPT-4 (Generative Pre-trained Transformer 4), or GPT-4o, or generative AI finely tuned using environmental information, spatial information, or the like.

The large-scale language model may be stored in the storage unit 20A of the information processing apparatus 1A or may be stored in a device other than the information processing apparatus 1A. Here, the large-scale language model being stored in the storage device (the storage unit 20A or the like) means that a parameter that defines the large-scale language model is stored in the storage device. In a case where the large-scale language model is stored in a device other than the information processing apparatus 1A, for example, the text generation unit 112A transmits input data to the device via the communication unit 30A, receives output data transmitted from the device, and generates the text based on the received output data.

### (Input to Large-Scale Language Model)

The input data input to the large-scale language model may include a reference text generated by the reference text generation unit 111A in addition to the sensor information, the guide information, and the environmental information. In other words, the text generation unit 112A can generate the text using the reference text in addition to the sensor information, the guide information, and the environmental information.

The input data may include a division result by the area division unit 108A. In other words, in this case, it can be said that the text generation unit 112A generates the text using the division result by the area division unit 108A in addition to the sensor information, the guide information, and the environmental information.

The input data may include at least one of a detection result by the target detection unit 109A and a tracking result by the target tracking unit 110A. The input data may include accumulated past data. Here, the accumulated past data includes, as an example, at least one of the distance measuring sensor information acquired by the distance measuring sensor information acquisition unit 101A, the image sensor information acquired by the image sensor information acquisition unit 102A, the spatial information acquired by the spatial information acquisition unit 103A, the environmental information acquired by the environmental information acquisition unit 104A, the guide information acquired by the distance measuring sensor information guide acquisition unit 105A, the guide information acquired by the image sensor information guide acquisition unit 106A, the spatial information acquired by the spatial information guide acquisition unit 107A, the division result obtained by the area division unit 108A, the detection result detected by the target detection unit 109A, the trajectory obtained by the target tracking unit 110A, and the reference text generated by the reference text generation unit 111A.

The input data may include an instruction sentence. The instruction sentence is, for example, a text such as “The following shows the image on which the tracking target is superimposed, the date, the trajectory of the tracking target, the guide input by the user, and the environmental information (temperature, etc.). Please summarize them with reference to the past answer text”.

### (Output of Large-Scale Language Model)

As an example, the output of the large-scale language model includes text indicating an explanatory sentence (report, instructions on work, etc.) gazing at an event indicated by the guide information in the guide input image. The text is, for example, a text such as “At yy:zz on the xx-th, bb (target object) passed near point aa in a state of cc (speed, etc.). There is a possibility that it will pass dd in the future. As a similar case in the past, it passed kk point and mm point at hh:jj on ff gg, ee. At that time, it was determined that nn (for example, action such as rescue)”. The output of the large-scale language model may include data other than text (image data, voice data, and the like).

### (Output Adjustment Unit)

The output adjustment unit 113A tunes at least one of the large-scale language model and the input data using the guide information. More specifically, as an example, the output adjustment unit 113A acquires a training text relevant to the guide information, and performs fine tuning or instruction tuning on the large-scale language model using the guide information and the training text. The output adjustment unit 113A may perform prompt tuning using the guide information and the training text. Here, the training text is, for example, a text output by the large-scale language model in the past.

As an example, the training data used for tuning includes a plurality of sets of first data including at least one of the image sensor information acquired by the image sensor information acquisition unit 102A, the distance measuring sensor information acquired by the distance measuring sensor information acquisition unit 101A, the spatial information acquired by the spatial information acquisition unit 103A, the environmental information acquired by the environmental information acquisition unit 104A, the guide information acquired by the distance measuring sensor information guide acquisition unit 105A, the guide information acquired by the image sensor information guide acquisition unit 106A, the guide information acquired by the spatial information guide acquisition unit 107A, the division result acquired by the area division unit 108A, the detection result by the target detection unit 109A, the tracking result by the target tracking unit 110A, and the reference text generated by the reference text generation unit 111A, and the text (training text) relevant to the first data.

### (Text Output Unit)

The text output unit 114A outputs the text generated by the text generation unit 112A. As an example, the text output unit 114A outputs the text to a display connected to the output unit 50A, and causes the display to display the text. The text output unit 114A may transmit the text to another device connected via the communication unit 30A and cause a display of the another device to display the text. A text A24 in FIG. 6 is an example of the text output by the text output unit 114A. In the example of FIG. 6, the text A24 is displayed on the display together with the images A21 to A23 in which the guide information is superimposed on the guide input image.

The text output unit 114A may also write and output the text to a storage destination (a storage device in the information processing apparatus 1A or a storage device outside the information processing apparatus 1A may be used) designated by the user of the information processing apparatus 1A. The text output unit 114A may output the text to an output device such as a speaker or a printer.

### (Application Example)

The information processing apparatus 1A according to the present disclosure is applicable to various technical fields such as robotics, logistics systems, and drone control. For example, in the case of robotics, the guide information according to the present disclosure includes, as an example, information indicating a figure (for example, a connection line) indicating that a robot moving an object is relevant to an object moved by the robot, and information indicating a figure indicating an entry prohibited area for the robot. In this case, the text generated by the text generation unit 112A is, for example, a report for explaining work content by the robot, an instruction regarding work, or the like.

For example, in the case of a logistics system, the guide information includes, as an example, information indicating a figure (for example, a connection line) indicating a relationship between a delivery vehicle that delivers a product and a storage place of the product to be delivered, and information indicating a no traffic area due to an accident or the like. In this case, the text generated by the text generation unit 112A is, for example, a work report regarding a delivery work using a delivery vehicle, an instruction regarding the work, or the like.

### (Effects of Information Processing Apparatus)

By the way, in the conventional technology, there is a problem that even if a text (report or the like) is created from spatial information or the like, it does not become an explanatory sentence focusing on an important part. In large-scale image/video data/radar information processing, it is difficult to output an explanatory sentence (report or the like) focusing on a specific region only by controlling a text prompt. It is difficult to input prompt engineering for dealing with a small area in the target data, a relationship (context) with an object or a person, a correlation between time and space, and the like in text. On the other hand, according to the information processing apparatus 1A of the present disclosure, using the guide information in addition to the sensor information and the environmental information, it is possible to generate a text having contents focusing on a specific event in a space that is a monitoring target.

The information processing apparatus 1A employs a configuration in which the sensor information includes distance measuring sensor information acquired from a distance measuring sensor and image sensor information acquired from an image sensor, the information processing apparatus 1A includes the display control unit 115A that displays, on a display device, a first image represented by the distance measuring sensor information, a second image represented by the image sensor information, and a third image represented by spatial information representing a space, and the distance measuring sensor information guide acquisition unit 105A, the image sensor information guide acquisition unit 106A, and the spatial information guide acquisition unit 107A acquire guide information input by the user with respect to at least one of the first image, the second image, and the third image displayed by the display control unit 115A.

In the conventional technique, even if a text (report or the like) is created from spatial information, there is a case where an explanatory sentence focusing on an important part is not obtained. On the other hand, according to the information processing apparatus 1A of the present disclosure, it is possible to generate a text reflecting the intention of the user using the guide information input by the user.

The information processing apparatus 1A employs a configuration including the target detection unit 109A that detects a target existing in a space using sensor information and the target tracking unit 110A that tracks the target detected by the target detection unit 109A, in which the guide information includes information indicating at least one of a detection result by the target detection unit 109A and a tracking result by the target tracking unit 110A. Therefore, according to the information processing apparatus 1A, it is possible to generate a text of contents focusing on the detection result of the target or the tracking result of the target.

The information processing apparatus 1A further includes a reference text generation means for generating a reference text based on output data obtained by inputting the sensor information to the generative model, and the text generation unit 112A generates the text using the reference text in addition to the sensor information, the guide information, and the environmental information. Therefore, according to the information processing apparatus 1A, the text can be generated more accurately using the reference text.

The information processing apparatus 1A includes the area division unit 108A that performs area division on the sensor information, and the text generation unit 112A generates a text using a division result by the area division unit 108A in addition to the sensor information, the guide information, and the environmental information. Therefore, according to the information processing apparatus 1A, the text can be generated more accurately using the area obtained by the area division.

The information processing apparatus 1A employs a configuration in which the text generation unit 112A generates a text based on output data obtained by inputting input data including sensor information, guide information, and environmental information to a large-scale language model, and includes the output adjustment unit 113A that tunes at least one of the large-scale language model and the input data using the guide information. Therefore, according to the information processing apparatus 1A, it is possible to generate the text with higher accuracy using the large-scale language model updated by the output adjustment unit 113A.

In the information processing apparatus 1A, the output adjustment unit 113A acquires a training text relevant to guide information, and performs fine tuning or instruction tuning of a large-scale language model using the guide information and the training text. Therefore, according to the information processing apparatus 1A, it is possible to generate the text with higher accuracy using the large-scale language model updated by the output adjustment unit 113A.

The information processing apparatus 1A employs a configuration in which the guide information is information indicating a superimposed image in which a figure indicating at least one of the shape of the target included in the space, the trajectory of the movement of the target, the relationship between the targets, and the boundary in the space is superimposed on at least one of the image indicating the space and the image indicated by the sensor information. Therefore, according to the information processing apparatus 1A, it is possible to generate a text of contents focusing on a specific event in a space to be monitored.

### Implementation Example by Software

Some or all of the functions of the information processing apparatuses 1, 1A, and 2 (hereinafter, also referred to as “each of the above apparatuses”) may be implemented by hardware such as an integrated circuit (an IC chip) or may be implemented by software.

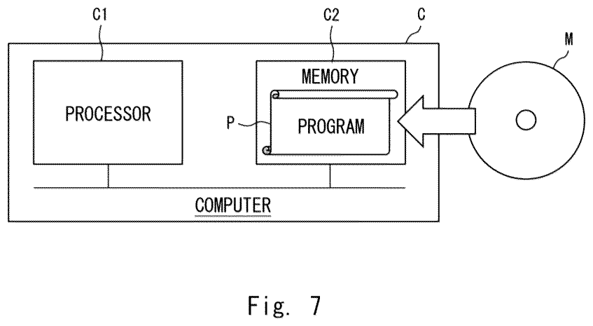

In the latter case, each of the above apparatuses is achieved by, for example, a computer that executes a command of a program as software for achieving each function. An example of such a computer (hereinafter, referred to as a computer C) is illustrated in FIG. 7. FIG. 7 is a block diagram illustrating a hardware configuration of the computer C functioning as each of the above apparatuses.

The computer C includes at least one processor C1 and at least one memory C2. A program P causing the computer C to operate as each of the above apparatuses is recorded in the memory C2. In the computer C, by the processor C1 reading the program P from the memory C2 and executing the program P, each function of each of the above apparatuses is achieved.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these can be used. As the memory C2, for example, a flash memory, a hard disk drive (HDD), a solid state drive (SSD), or a combination of these can be used.

The computer C may further include a random access memory (RAM) for loading the program P at the time of execution and temporarily storing various types of data. The computer C may further include a communication interface for transmitting and receiving data to and from another device. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, or a programmable logic circuit can be used. The computer C can acquire the program P via such a recording medium M. The program P can be transmitted via a transmission medium. As such a transmission medium, for example, a communication network or a broadcast wave can be used. The computer C can also acquire the program P via such a transmission medium.

Each of the above functions of each of the above apparatuses may be achieved by a single processor provided in a single computer, may be achieved in cooperation with a plurality of processors provided in a single computer, or may be achieved in cooperation with a plurality of processors provided in a plurality of computers. The program for causing each of the above apparatuses to achieve each of the above functions may be stored in a single memory provided in a single computer, may be stored in a distributed manner in a plurality of memories provided in a single computer, or may be stored in a distributed manner in a plurality of memories provided in a plurality of computers.

### Supplementary Note A

The present disclosure includes technologies described in the following Supplementary Notes. However, the present invention is not limited to the technologies described in the following Supplementary Notes, and various modifications can be made within the scope described in the claims.

### (Supplementary Note A1)

An information processing apparatus including:
an acquisition means for acquiring sensor information indicating a sensing result by a sensor that senses a space and environmental information regarding an environment of the space;
a guide information acquisition means for acquiring guide information indicating at least one of a shape of a target included in the space, a trajectory of movement of the target, a relationship between targets, and a boundary in the space;
a text generation means for generating a text describing the space using the sensor information, the guide information, and the environmental information; and
a text output means for outputting a text generated by the text generation means.

### (Supplementary Note A2)

The information processing apparatus according to Supplementary Note A1, in which
the sensor information includes distance measuring sensor information acquired from a radar and image sensor information acquired from an image sensor,
the information processing apparatus further includes a display control means for displaying, on a display device, a first image represented by the distance measuring sensor information, a second image represented by the image sensor information, and a third image represented by spatial information representing the space, and
the guide information acquisition means acquires the guide information input by a user to at least one of the first image, the second image, and the third image displayed by the display control means.

### (Supplementary Note A3)

The information processing apparatus according to Supplementary Note A1 or A2, further including:
a target detection means for detecting a target existing in the space using the sensor information; and
a target tracking means for tracking a target detected by the target detection means,
in which the guide information includes information indicating at least one of a detection result by the target detection means and a tracking result by the target tracking means.

### (Supplementary Note A4)

The information processing apparatus according to any one of Supplementary Notes A1 to A3, further including a reference text generation means for generating a reference text based on output data obtained by inputting the sensor information to a generative model,
in which the text generation means generates the text using the reference text in addition to the sensor information, the guide information, and the environmental information.

### (Supplementary Note A5)

The information processing apparatus according to any one of Supplementary Notes A1 to A4, further including an area division means for performing area division on the sensor information,
in which the text generation means generates the text using a division result by the area division means in addition to the sensor information, the guide information, and the environmental information.

### (Supplementary Note A6)

The information processing apparatus according to any one of Supplementary Notes A1 to A5, in which
the text generation means generates the text based on output data obtained by inputting input data including the sensor information, the guide information, and the environmental information to a large-scale language model, and
the information processing apparatus further includes an output adjustment means for tuning at least one of the large-scale language model and the input data using the guide information.

### (Supplementary Note A7)

The information processing apparatus according to Supplementary Note A6, in which the output adjustment means acquires a training text relevant to the guide information, and performs fine tuning or instruction tuning on the large-scale language model using the guide information and the training text.

### (Supplementary Note A8)

The information processing apparatus according to any one of Supplementary Notes A1 to A7, in which the guide information is information indicating a superimposed image in which a figure indicating at least one of a shape of a target included in the space, a trajectory of movement of the target, a relationship between targets, and a boundary in the space is superimposed on at least one of the image indicating the space and the image indicated by the sensor information.

### Supplementary Note B

The present disclosure includes technologies described in the following Supplementary Notes. However, the present invention is not limited to the technologies described in the following Supplementary Notes, and various modifications can be made within the scope described in the claims.

### (Supplementary Note B1)

An information processing method including:
acquisition processing of acquiring, by at least one processor, sensor information indicating a sensing result by a sensor that senses a space and environmental information regarding an environment of the space;
guide information acquisition processing of acquiring, by the at least one processor, guide information indicating at least one of a shape of a target included in the space, a trajectory of movement of the target, a relationship between targets, and a boundary in the space;
text generation processing of generating, by the at least one processor, a text describing the space using the sensor information, the guide information, and the environmental information; and
text output processing of outputting, by the at least one processor, a text generated in the text generation processing.

### (Supplementary Note B2)

The information processing method according to Supplementary Note B1, in which
the sensor information includes distance measuring sensor information acquired from a radar and image sensor information acquired from an image sensor,
the information processing method further includes display control processing of displaying, on a display device by the at least one processor, a first image represented by the distance measuring sensor information, a second image represented by the image sensor information, and a third image represented by spatial information representing the space, and
in the guide information acquisition processing, the at least one processor acquires the guide information input by a user to at least one of the first image, the second image, and the third image displayed in the display control processing.

### (Supplementary Note B3)

The information processing method according to Supplementary Note B1 or B2, further including:
target detection processing of detecting, by the at least one processor, a target existing in the space using the sensor information; and
target tracking processing of tracking, by the at least one processor, a target detected in the target detection processing,
in which the guide information includes information indicating at least one of a detection result by the target detection processing and a tracking result by the target tracking processing.

### (Supplementary Note B4)

The information processing method according to any one of Supplementary Notes B1 to B3, further including reference text generation processing of generating, by the at least one processor, a reference text based on output data obtained by inputting the sensor information to a generative model,
in which in the text generation processing, the at least one processor generates the text using the reference text in addition to the sensor information, the guide information, and the environmental information.

### (Supplementary Note B5)

The information processing method according to any one of Supplementary Notes B1 to B4, further including area division processing of performing, by the at least one processor, area division on the sensor information,
in which in the text generation processing, the at least one processor generates the text using a division result by the area division processing in addition to the sensor information, the guide information, and the environmental information.

### (Supplementary Note B6)

The information processing method according to any one of Supplementary Notes B1 to B5, in which
in the text generation processing, the at least one processor generates the text based on output data obtained by inputting input data including the sensor information, the guide information, and the environmental information to a large-scale language model, and
the information processing method further includes output adjustment processing of tuning, by the at least one processor, at least one of the large-scale language model and the input data using the guide information.

### (Supplementary Note B7)

The information processing method according to Supplementary Note B6, in which in the output adjustment processing, the at least one processor acquires a training text relevant to the guide information, and performs fine tuning or instruction tuning on the large-scale language model using the guide information and the training text.

### (Supplementary Note B8)

The information processing method according to any one of Supplementary Notes B1 to B7, in which the guide information is information indicating a superimposed image in which a figure indicating at least one of a shape of a target included in the space, a trajectory of movement of the target, a relationship between targets, and a boundary in the space is superimposed on at least one of the image indicating the space and the image indicated by the sensor information.

### Supplementary Note C

The present disclosure includes technologies described in the following Supplementary Notes. However, the present invention is not limited to the technologies described in the following Supplementary Notes, and various modifications can be made within the scope described in the claims.

### (Supplementary Note C1)

An information processing program for causing a computer to function as an information processing apparatus, the information processing program causing the computer to function as:
an acquisition means for acquiring sensor information indicating a sensing result by a sensor that senses a space and environmental information regarding an environment of the space;
a guide information acquisition means for acquiring guide information indicating at least one of a shape of a target included in the space, a trajectory of movement of the target, a relationship between targets, and a boundary in the space;
a text generation means for generating a text describing the space using the sensor information, the guide information, and the environmental information; and
a text output means for outputting a text generated by the text generation means.

### (Supplementary Note C2)

The information processing program according to Supplementary Note C1, in which
the sensor information includes distance measuring sensor information acquired from a radar and image sensor information acquired from an image sensor,
the information processing program causes the computer to further function as:
a display control means for displaying, on a display device, a first image represented by the distance measuring sensor information, a second image represented by the image sensor information, and a third image represented by spatial information representing the space, and
the guide information acquisition means acquires the guide information input by a user to at least one of the first image, the second image, and the third image displayed by the display control means.

### (Supplementary Note C3)

The information processing program according to Supplementary Note C1 or C2, the program causing the computer to further function as:
a target detection means for detecting a target existing in the space using the sensor information; and
a target tracking means for tracking a target detected by the target detection means,
in which the guide information includes information indicating at least one of a detection result by the target detection means and a tracking result by the target tracking means.

### (Supplementary Note C4)

The information processing program according to any one of Supplementary Notes C1 to C3, the program causing the computer to further function as a reference text generation means for generating a reference text based on output data obtained by inputting the sensor information to a generative model,
in which the text generation means generates the text using the reference text in addition to the sensor information, the guide information, and the environmental information.

### (Supplementary Note C5)

The information processing program according to any one of Supplementary Notes C1 to C4, the program causing the computer to function as an area division means for performing area division on the sensor information,
in which the text generation means generates the text using a division result by the area division means in addition to the sensor information, the guide information, and the environmental information.

### (Supplementary Note C6)

The information processing program according to any one of Supplementary Notes C1 to C5, in which
the text generation means generates the text based on output data obtained by inputting input data including the sensor information, the guide information, and the environmental information to a large-scale language model, and
the information processing program causes the computer to further function as an output adjustment means for tuning at least one of the large-scale language model and the input data using the guide information.

### (Supplementary Note C7)

The information processing program according to Supplementary Note C6, in which the output adjustment means acquires a training text relevant to the guide information, and performs fine tuning or instruction tuning on the large-scale language model using the guide information and the training text.

### (Supplementary Note C8)

The information processing program according to any one of Supplementary Notes C1 to C7, in which the guide information is information indicating a superimposed image in which a figure indicating at least one of a shape of a target included in the space, a trajectory of movement of the target, a relationship between targets, and a boundary in the space is superimposed on at least one of the image indicating the space and the image indicated by the sensor information.

### Supplementary Note D

The present disclosure includes technologies described in the following Supplementary Notes. However, the present invention is not limited to the technologies described in the following Supplementary Notes, and various modifications can be made within the scope described in the claims.

### (Supplementary Note D1)

### An Information Processing Apparatus Including

at least one processor,
in which the at least one processor executes:
acquisition processing of acquiring sensor information indicating a sensing result by a sensor that senses a space and environmental information regarding an environment of the space;
guide information acquisition processing of acquiring guide information indicating at least one of a shape of a target included in the space, a trajectory of movement of the target, a relationship between targets, and a boundary in the space;
text generation processing of generating a text describing the space using the sensor information, the guide information, and the environmental information; and
text output processing of outputting a text generated in the text generation processing.

The information processing apparatus may further include a memory. The memory may store a program for causing the at least one processor to execute each of the processing.

### (Supplementary Note D2)

The information processing apparatus according to Supplementary Note D1, in which
the sensor information includes distance measuring sensor information acquired from a radar and image sensor information acquired from an image sensor,
the at least one processor further executes display control processing of displaying, on a display device by the at least one processor, a first image represented by the distance measuring sensor information, a second image represented by the image sensor information, and a third image represented by spatial information representing the space, and
in the guide information acquisition processing, the at least one processor acquires the guide information input by a user to at least one of the first image, the second image, and the third image displayed in the display control processing.

### (Supplementary Note D3)

The information processing apparatus according to Supplementary Note D1 or D2, in which
the at least one processor further executes:
target detection processing of detecting a target existing in the space using the sensor information; and
target tracking processing of tracking a target detected in the target detection processing, and
the guide information includes information indicating at least one of a detection result by the target detection processing and a tracking result by the target tracking processing.

### (Supplementary Note D4)

The information processing apparatus according to any one of Supplementary Notes D1 to D3, in which
the at least one processor further executes reference text generation processing of generating a reference text based on output data obtained by inputting the sensor information to a generative model, and
in the text generation processing, the at least one processor generates the text using the reference text in addition to the sensor information, the guide information, and the environmental information.

### (Supplementary Note D5)

The information processing apparatus according to any one of Supplementary Notes D1 to D4, in which the at least one processor further executes area division processing of performing area division on the sensor information, and
in the text generation processing, the at least one processor generates the text using a division result by the area division processing in addition to the sensor information, the guide information, and the environmental information.

### (Supplementary Note D6)

The information processing apparatus according to any one of Supplementary Notes D1 to D5, in which
in the text generation processing, the at least one processor generates the text based on output data obtained by inputting input data including the sensor information, the guide information, and the environmental information to a large-scale language model, and
the at least one processor further executes output adjustment processing of tuning at least one of the large-scale language model and the input data using the guide information.

### (Supplementary Note D7)

The information processing apparatus according to Supplementary Note D6, in which in the output adjustment processing, the at least one processor acquires a training text relevant to the guide information, and performs fine tuning or instruction tuning on the large-scale language model using the guide information and the training text.

### (Supplementary Note D8)

The information processing apparatus according to any one of Supplementary Notes D1 to D7, in which the guide information is information indicating a superimposed image in which a figure indicating at least one of a shape of a target included in the space, a trajectory of movement of the target, a relationship between targets, and a boundary in the space is superimposed on at least one of the image indicating the space and the image indicated by the sensor information.

### Supplementary Note E

The present disclosure includes technologies described in the following Supplementary Notes. However, the present invention is not limited to the technologies described in the following Supplementary Notes, and various modifications can be made within the scope described in the claims.

### (Supplementary Note E1)

A non-transitory recording medium having stored therein an information processing program for causing a computer to function as an information processing apparatus, the program causing the computer to execute:
acquisition processing of acquiring sensor information indicating a sensing result by a sensor that senses a space and environmental information regarding an environment of the space;
guide information acquisition processing of acquiring guide information indicating at least one of a shape of a target included in the space, a trajectory of movement of the target, a relationship between targets, and a boundary in the space;
text generation processing of generating a text describing the space using the sensor information, the guide information, and the environmental information; and
text output processing of outputting a text generated in the text generation processing.

1. An information processing apparatus comprising:
at least one memory storing instructions; and
at least one processor configured to execute the instructions to;
acquire sensor information indicating a sensing result by a sensor that senses a space and environmental information regarding an environment of the space;
acquire guide information indicating at least one of a shape of a target included in the space, a trajectory of movement of the target, a relationship between targets, and a boundary in the space;
generate a text describing the space using the sensor information, the guide information, and the environmental information; and
output a text generated.

2. The information processing apparatus according to claim 1, wherein
the sensor information includes distance measuring sensor information acquired from a distance measuring sensor and image sensor information acquired from an image sensor, wherein the at least one processor is further configured to execute the instructions to;
display, on a display device, a first image represented by the distance measuring sensor information, a second image represented by the image sensor information, and a third image represented by spatial information representing the space; and
acquire the guide information input by a user to at least one of the first image, the second image, and the third image displayed.

3. The information processing apparatus according to claim 1, wherein the at least one processor is further configured to execute the instructions to;
detect a target existing in the space using the sensor information;
track the target; and
wherein the guide information includes information indicating at least one of a detection result and a tracking result.

4. The information processing apparatus according to claim 1, wherein the at least one processor is further configured to execute the instructions to;
generate a reference text based on output data obtained by inputting the sensor information to a generative model; and
generate the text using the reference text in addition to the sensor information, the guide information, and the environmental information.

5. The information processing apparatus according to claim 1, wherein the at least one processor is further configured to execute the instructions to;
perform area division on the sensor information; and
generate the text using a division result in addition to the sensor information, the guide information, and the environmental information.

6. The information processing apparatus according to claim 1, wherein the at least one processor is further configured to execute the instructions to;
generate the text based on output data obtained by inputting input data including the sensor information, the guide information, and the environmental information to a large-scale language model; and
tune at least one of the large-scale language model and the input data using the guide information.

7. The information processing apparatus according to claim 6, wherein the at least one processor is further configured to execute the instructions to;
acquire a training text relevant to the guide information; and
perform fine tuning or instruction tuning on the large-scale language model using the guide information and the training text.

8. The information processing apparatus according to claim 2, wherein the guide information is information indicating a superimposed image in which a figure indicating at least one of a shape of a target included in the space, a trajectory of movement of the target, a relationship between targets, and a boundary in the space is superimposed on at least one of the image indicating the space and the image indicated by the sensor information.

9. An information processing method comprising:
acquisition processing of acquiring, by at least one processor, sensor information indicating a sensing result by a sensor that senses a space and environmental information regarding an environment of the space;
guide information acquisition processing of acquiring, by the at least one processor, guide information indicating at least one of a shape of a target included in the space, a trajectory of movement of the target, a relationship between targets, and a boundary in the space;
text generation processing of generating, by the at least one processor, a text describing the space using the sensor information, the guide information, and the environmental information; and
text output processing of outputting, by the at least one processor, a text generated in the text generation processing.

10. A non-transitory recording medium having stored therein an information processing program for causing a computer to function as an information processing apparatus, the program causing the computer to execute:
acquisition processing of acquiring sensor information indicating a sensing result by a sensor that senses a space and environmental information regarding an environment of the space;
guide information acquisition processing of acquiring guide information indicating at least one of a shape of a target included in the space, a trajectory of movement of the target, a relationship between targets, and a boundary in the space;
text generation processing of generating a text describing the space using the sensor information, the guide information, and the environmental information; and
text output processing of outputting a text generated in the text generation processing.
